(19) United States
(12) Patent Application Publication
(10) Pub. No.: US 2024/0401218 A1
(43) Pub. Date: Dec. 5, 2024

(54) A SYSTEM FOR AN ELECTROCHEMICAL PROCESS AND A METHOD FOR PREVENTING DEGRADATION OF ELECTRODES

(71) Applicant: NEOVOLT OY, Vantaa (FI)

(72) Inventors: Joonas KOPONEN, Vantaa (FI); Anton KRIMER, Vantaa (FI); Olli LIUKKONEN, Vantaa (FI)

(21) Appl. No.: 18/698,258

(22) PCT Filed: Sep. 22, 2022
(86) PCT No.: PCT/FI2022/050636

§ 371 Date: Apr. 3, 2024

(30) Foreign Application Priority Data
Oct. 6, 2021 (FI) 20216033

(51) Int. Cl. C25B 15/031; C25B 1/04; C25B 9/65; C25B 9/67; C25B 15/021

(52) U.S. Cl. CPC C25B 15/031; C25B 1/04; C25B 9/65; C25B 9/67; C25B 15/021

(57) ABSTRACT

A system for an electrochemical process comprises an electrochemical reactor (101), an electric power source (104) for supplying controllable direct voltage to electrodes of the electrochemical reactor, a measurement apparatus (105) for producing measurement data indicative of formation of product gases of the system, and a controller (106) configured to reduce the direct voltage when: an idle command to set the system into an idle state has been received, the measurement data indicates formation of the product gas, and the direct voltage is above a lower limit of a safe voltage area free from degradation of the electrodes. Thus, in the idle state, the direct voltage is reduced only by an amount needed for stopping the product gas formation but not more. Therefore, the degradation such as corrosion of the electrodes can be avoided or at least reduced in the idle state.

### FIELD OF THE DISCLOSURE

The disclosure relates to a system for an electrochemical process such as e.g. alkaline water electrolysis, proton exchange membrane “PEM” water electrolysis, or electrolysis of brine. Furthermore, the disclosure relates to a method for preventing degradation, e.g. corrosion, of electrodes of an electrochemical reactor. Furthermore, the disclosure relates to a computer program for preventing degradation of electrodes of an electrochemical reactor.

### BACKGROUND

An electrochemical process where material interacts with electrodes can be for example an electrolysis process such as e.g. water electrolysis where electrical energy is converted into chemical energy carried by hydrogen gas H₂, and oxygen gas O₂ is produced as a side-product. Direct current is passed between electrodes, and hydrogen gas is produced at the cathode i.e. the negative electrode, and oxygen gas is produced at the anode i.e. the positive electrode. The Faraday's law of electrolysis states that the production of hydrogen gas is directly proportional to the electric charge transferred at the electrodes. Thus, the mean value of the direct current determines the production rate of hydrogen gas.

Alkaline water electrolysis is widely used and mature water electrolysis technology. Alkaline water electrolysis reactor comprises electrodes operating in a liquid electrolyte solution, e.g. potassium hydroxide KOH or sodium hydroxide NaOH. The electrodes are separated by a non-conducting porous diaphragm. The diaphragm prevents mixing of hydrogen H₂ and oxygen O₂ gases produced at cathode and anode electrodes, respectively. Hydroxide ions are penetrating the porous diaphragm and thereby provide ionic conductivity required for the electrolysis process. A stack structure of an alkaline water electrolysis reactor may comprise relatively low-cost materials such as nickel as electrodes and stainless steel. Another water electrolysis technology is proton exchange membrane “PEM” water electrolysis. In contrast to the alkaline water electrolysis, PEM water electrolysis reactor utilize solid and acidic electrolytes. The electrolyte carries protons from anode to cathode and acts as a gas separator membrane. Typically, sulphonated fluoropolymers are used as the solid electrolyte. The sulphonic acid side chain HSO₃ of the polymer is ionically bonded, and due to the ionic bonding, there is a strong attraction between H+ and SO₃⁻, and therefore the sulphonic acid attracts water, and its proton conduction is dependent on hydration. Due to the acidity of the membrane, the catalyst materials for PEM water electrolysis reactor are typically selected from the platinum-group metals, most often iridium for the anode and platinum for the cathode. A third exemplifying electrolysis technology is electrolysis of brine such as a chlor-alkali electrolysis process.

Lifetime is an essential factor of electrolysis reactors of the kind mentioned above. Typically, the lifetime of a stack structure of an electrolysis reactor is about ten years, and stack structures represents typically about a half of investment costs of an industrial electrolysis plant. The lifetime of industrial electrolysis reactors is characterized by operating hours and maximum number of start-stop cycles. Cathode degradation is a factor limiting the lifetime of the stack structure. The cathode degradation further intensifies when operation of the electrolysis reactor is interrupted, and direct voltage supplied to the electrodes falls below the system-specific voltage limit. This voltage limit is defined by material of each electrode, as well as operating conditions such as temperature, pressure, and pH of electrolyte.

Publication TW201308741A describes a method for preventing voltage inversion in a water electrolysis cell when the water electrolysis cell is in an idle state and thereby stopped from producing hydrogen gas. The method presented in TW201308741A comprises supplying, to electrodes of the water electrolysis cell, protective voltage that is lower than á priori known voltage needed to start and maintain a water electrolysis process in the water electrolysis cell. The method presented in TW201308741A is however not free from challenges. One of the challenges is related to typical industrial electrochemical reactors which comprise multiple cells connected in series and possibly a parallel connection of series connected sections. In these electrochemical reactors, the stack voltage does not reveal information how individual cell voltages are divided. Therefore, it can be challenging to determine a suitable protective voltage for an industrial electrochemical reactor of the kind mentioned above.

### SUMMARY

The following presents a simplified summary in order to provide a basic understanding of some aspects of various embodiments. The summary is not an extensive overview of the invention. It is neither intended to identify key or critical elements of the invention nor to delineate the scope of the invention. The following summary merely presents some concepts in a simplified form as a prelude to a more detailed description of exemplifying and non-limiting embodiments.

In accordance with the invention, there is provided a new system for an electrochemical process that can be, for example but not necessarily, alkaline water electrolysis, proton exchange membrane “PEM” water electrolysis, or electrolysis of brine such as a chlor-alkali electrolysis process.

A system according to the invention comprises:
an electrochemical reactor for containing electrolyte and comprising electrodes for directing electric current to the electrolyte,
an electric power source configured to supply controllable direct voltage to the electrodes of the electrochemical reactor,
a measurement apparatus configured to produce measurement data indicative of formation of at least one product gas, e.g. hydrogen gas H₂, of the system, and
a controller communicatively connected to the electric power source and to the measurement apparatus and configured to reduce the direct voltage in response to a situation in which i) the controller has received an idle command to set the system into an idle state, ii) the measurement data indicates formation of the product gas, and iii) the direct voltage is above a lower limit of a safe voltage area free from degradation of the electrodes.

Thus, in the idle state, the direct voltage is reduced only by an amount needed for stopping the product gas formation but not more. Therefore, degradation such as corrosion of the electrodes can be avoided or at least reduced in the idle state. This lengthens the lifetime of the electrochemical reactor.

In accordance with the invention, there is also provided a new method for preventing degradation, such as corrosion, of electrodes of an electrochemical reactor during an idle state of the electrochemical reactor. A method according to the invention comprises:
supplying controllable direct voltage to the electrodes of the electrochemical reactor,
producing measurement data indicative of formation of at least one product gas of the electrochemical reactor, and
reducing the direct voltage in response to a situation in which i) the measurement data indicates formation of the product gas, and ii) the direct voltage is above a lower limit of a safe voltage area free from degradation of the electrodes.

In accordance with the invention, there is also provided a new computer program for preventing degradation of electrodes of an electrochemical reactor during an idle state of the electrochemical reactor. A computer program according to the invention comprises computer executable instructions for controlling a programmable processor to:
control an electric power source to supply controllable direct voltage to the electrodes of the electrochemical reactor,
receive measurement data indicative of formation of at least one product gas of the electrochemical reactor, and
control the electric power source to reduce the direct voltage in response to a situation in which i) the measurement data indicates formation of the product gas, and ii) the direct voltage is above a lower limit of a safe voltage area free from degradation of the electrodes.

In accordance with the invention, there is provided also a new computer program product. The computer program product comprises a non-volatile computer readable medium, e.g. a compact disc “CD”, encoded with a computer program according to the invention.

Exemplifying and non-limiting embodiments are described in accompanied dependent claims.

Various exemplifying and non-limiting embodiments both as to constructions and to methods of operation, together with additional objects and advantages thereof, will be best understood from the following description of specific exemplifying and non-limiting embodiments when read in conjunction with the accompanying drawings.

The verbs “to comprise” and “to include” are used in this document as open limitations that neither exclude nor require the existence of unrecited features.

The features recited in dependent claims are mutually freely combinable unless otherwise explicitly stated.

Furthermore, it is to be understood that the use of “a” or “an”, i.e. a singular form, throughout this document does not exclude a plurality.

### BRIEF DESCRIPTION OF THE FIGURES

Exemplifying and non-limiting embodiments and their advantages are explained in greater detail below in the sense of examples and with reference to the accompanying drawings, in which:

FIG. 1 illustrates a system according to an exemplifying and non-limiting embodiment for an electrochemical process,

FIG. 2 illustrates an exemplifying Pourbaix diagram according to the prior art and utilized in a system according to an exemplifying and non-limiting embodiment for an electrochemical process, and

FIG. 3 shows a flowchart of a method according to an exemplifying and non-limiting embodiment for preventing degradation of electrodes of an electrochemical reactor.

### DESCRIPTION OF THE EXEMPLIFYING EMBODIMENTS

The specific examples provided in the description given below should not be construed as limiting the scope and/or the applicability of the appended claims. Lists and groups of examples provided in the description given below are not exhaustive unless otherwise explicitly stated.

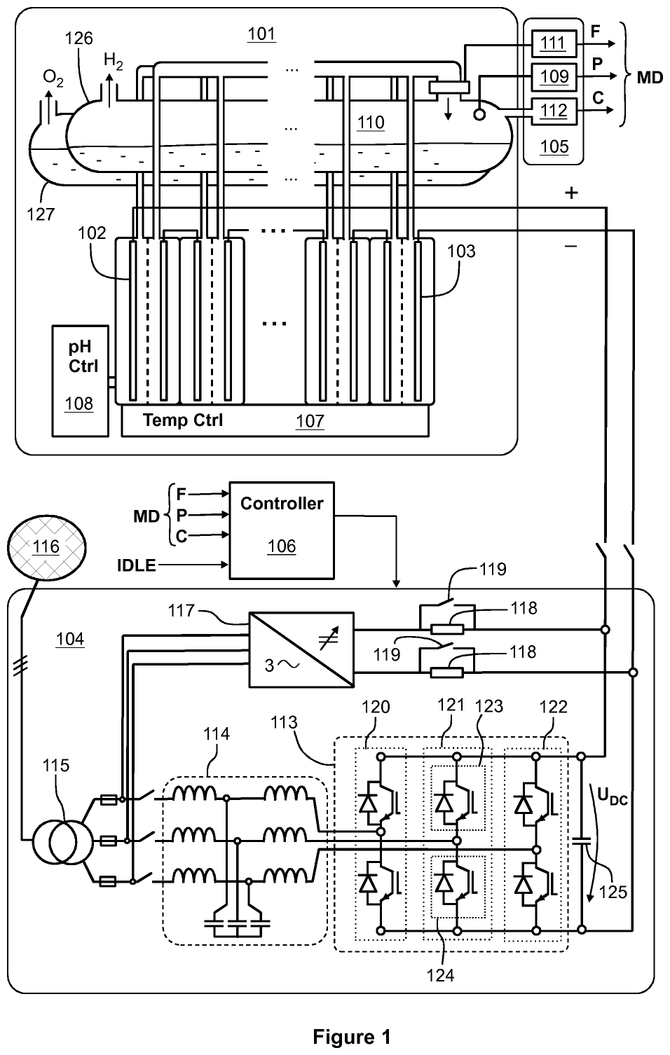

FIG. 1 illustrates a system according to an exemplifying and non-limiting embodiment for an electrochemical process. The system comprises an electrochemical reactor 101 for containing electrolyte and comprising electrodes for directing electric current to the electrolyte. In FIG. 1, two of the electrodes are denoted with references 102 and 103. In the exemplifying system illustrated in FIG. 1, the electrochemical reactor 101 comprises a stack of electrolysis cells. The electrolysis cells may contain for example alkaline liquid electrolyte for alkaline water electrolysis. The alkaline liquid electrolyte may comprise for example aqueous potassium hydroxide “KOH” or aqueous sodium hydroxide “NaOH”. It is however also possible that the electrolysis cells contain some other electrolyte. In this exemplifying system, each of the electrolytic cells comprises an anode, a cathode, and a porous diaphragm dividing the electrolysis cell into a cathode compartment containing the cathode and an anode compartment containing the anode. The diaphragm prevents mixing of hydrogen H₂ and oxygen O₂ gases produced at the cathode and anode electrodes respectively. Hydroxide ions are penetrating the porous diaphragm and thereby provide ionic conductivity required for the electrolysis process. The system may comprise for example tens or even hundreds of electrolysis cells. It is however also possible that a system according to an exemplifying and non-limiting embodiment comprises from one to ten electrolysis cells. In the exemplifying system illustrated in FIG. 1, the electrolysis cells are electrically series connected. It is however also possible that electrolytic cells of a system according to an exemplifying and non-limiting embodiment are electrically parallel connected, or the electrolytic cells are arranged to constitute series connected groups of parallel connected electrolytic cells, or parallel connected groups of series connected electrolytic cells, or the electrolytic cells are electrically connected to each other in some other way.

In the exemplifying system illustrated in FIG. 1, the electrochemical reactor 101 comprises a hydrogen separator tank 126 and a piping from the cathode compartments of the electrolysis cells to the hydrogen separator tank 126. The electrochemical reactor 101 comprises an oxygen separator tank 127 and a piping from the anode compartments of the electrolysis cells to the oxygen separator tank 127. The electrochemical reactor 101 may further comprises a circulation piping for circulating the liquid electrolyte from a lower portion of the hydrogen separator tank 126 and from a lower portion of the oxygen separator tank 127 back to the electrolysis cells. The circulation piping is not shown in FIG. 1.

The system comprises an electric power source 104 configured to supply controllable direct voltage ∪_{DC} to the electrodes of the electrochemical reactor 101. In the exemplifying system illustrated in FIG. 1, the electric power source 104 comprises a converter bridge 113 having alternating voltage terminals for receiving alternating voltages and direct voltage terminals for supplying direct current to the electrodes of the electrochemical reactor 101. The converter bridge 113 comprises converter legs 120, 121, and 122 each of which comprises one of the alternating voltage terminals and is connected between the direct voltage terminals. Each of the converter legs comprises a bi-directional upper-branch controllable switch between the alternating voltage terminal of the converter leg under consideration and a positive one of the direct voltage terminals and a bi-directional lower-branch controllable switch between the alternating voltage terminal of the converter leg under consideration and a negative one of the direct voltage terminals. In FIG. 1, the bi-directional upper-branch controllable switch of the converter leg 121 is denoted with a reference 123 and the bi-directional lower-branch controllable switch of the converter leg 121 is denoted with a reference 124. In this exemplifying case, each bi-directional controllable switch comprises an insulated gate bipolar transistor “IGBT” and an antiparallel diode. It is however also possible that each bi-directional controllable switch comprises e.g. a gate turn-off thyristor “GTO”, or a metal oxide field effect transistor “MOSFET”, or some other suitable semiconductor switch in lieu of the IGBT. Forced commutation of the bi-directional switches of the converter bridge 113 enables reduction of current ripple in the direct current supplied to the electrodes of the electrochemical reactor 101. Furthermore, the forced commutation of the bi-directional switches enables to control the power factor of an alternating voltage supply of the system.

In the exemplifying system illustrated in FIG. 1, the electric power source 104 comprises a transformer 115 for transferring electric power from an alternating voltage network 116 via an inductor-capacitor-inductor “LCL” filter 114 to the converter bridge 113. It is also possible that there are only serial inductances between the transformer 115 and the converter bridge 113 in lieu of the LCL filter 114. The secondary windings 115 of the transformer are connected via the LCL filter to the alternating voltage terminals of the converter bridge 113. The secondary voltage of the transformer 115 is advantageously selected to be so low that the converter bridge 113 can operate with a suitable duty cycle ratio of the controllable switches when the direct voltage ∪_{DC} is in a range suitable for the electrochemical reactor 101. The conversion from the alternating voltage to the direct voltage ∪_{DC} is done in a single-step, which typically leads to a voltage-boosting character for the converter bridge 113. The transformer 113 can be provided with a tap-changer for changing the transformation ratio of the transformer. The tap-changer is not shown in FIG. 1.

In the exemplifying system illustrated in FIG. 1, the electric power source 104 further comprises a charging converter 117 for controllably charging, during a start-up phase of the system, a direct voltage capacitor 125 connected to the direct voltage terminals of the converter bridge 113. The charging converter 117 may comprise for example thyristor bridge or some other suitable controllable alternating voltage-direct voltage “AC-DC” converter. Furthermore, the electric power source 104 comprises charging resistors 118 and bypass switches 119.

The system comprises a measurement apparatus 105 configured to produce measurement data MD that indicates whether hydrogen gas H₂ is produced in the electrochemical reactor 101. In a system according to an exemplifying and non-limiting embodiment, the measurement apparatus 105 comprises at least one pressure sensor 109 configured to detect gas pressure prevailing in a gas-space 110 of the electrochemical reactor 101. In this exemplifying case, an output signal of the pressure sensor 109 represents at least a part of the measurement data MD. In a system according to an exemplifying and non-limiting embodiment, the measurement apparatus 105 comprises at least one gas mass flow sensor 111 configured to detect gas mass flow from the electrolysis cells of the electrochemical reactor 101. In this exemplifying case, an output signal of the mass flow sensor represents at least a part of the measurement data MD. The gas mass flow sensor 111 may comprise for example a differential pressure flow meter and/or a thermal mass flow meter. In a system according to an exemplifying and non-limiting embodiment, the measurement apparatus 105 comprises a gas composition sensor 112 configured to detect a relative content of hydrogen gas H₂ within a sample of gas taken from the gas-space 110 of the electrochemical reactor 101. In this exemplifying case, an output signal of the gas composition sensor 112 represents at least a part of the measurement data MD. The gas composition sensor 112 may comprise for example a gas chromatographer and/or a mass spectrometer. In the exemplifying system illustrated in FIG. 1, the measurement apparatus 105 comprises the pressure sensor 109, the gas mass flow sensor 111, and the gas composition sensor 112 to improve reliability of the measurement data MD. It is however also possible a measurement apparatus of a system according to an exemplifying and non-limiting embodiment comprises only one or two of the above-mentioned devices for detecting whether hydrogen gas H₂ is produced.

The system comprises a controller 106 that is communicatively connected to the electric power source 104 and to the measurement apparatus 105. The controller 106 is configured to reduce the direct voltage ∪_{DC} in response to a situation in which i) the controller 106 has received an idle command to set the system into an idle state, ii) the measurement data MD indicates formation of hydrogen gas H₂, and iii) the direct voltage ∪_{DC} is above a lower limit of a safe voltage area in which degradation of the electrodes does not take place. In a system according to an exemplifying and non-limiting embodiment, the controller 106 comprises a memory configured to store data descriptive of a Pourbaix diagram of materials of the electrodes, and the controller 106 is configured to read the lower limit of the safe voltage area from the data descriptive of the Pourbaix diagram.

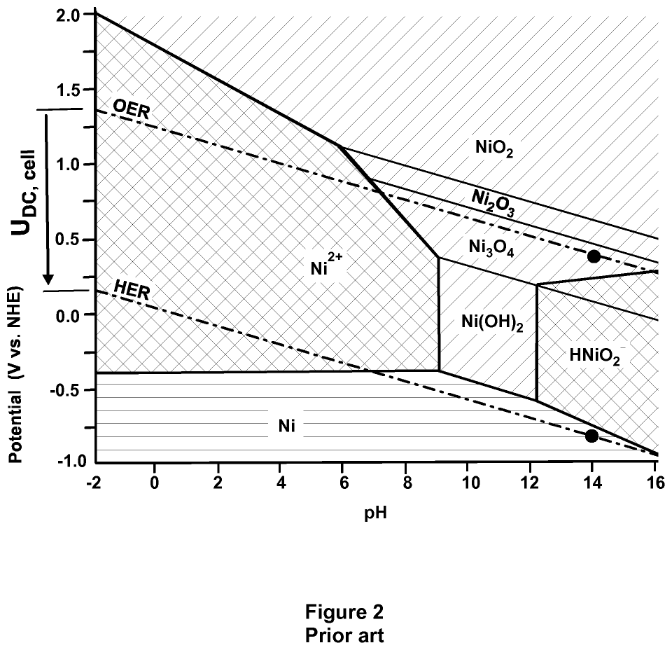

An exemplifying Pourbaix diagram for nickel electrodes is shown in FIG. 2. Oxygen evolution reaction “OER” and hydrogen evolution reaction “HER” potentials against a normal hydrogen electrode “NHE” are presented with dash-and-dot lines which can be determined based on the Nernst equation. The reactions involve both electron transfer and proton exchange. The OER and HER lines represent the equilibrium points for specific pH-levels when the respective half-reactions can take place. To split water with electrical energy, the potential difference between the anode and the cathode in each electrolytic cell must be greater than the difference between the OER and HER lines. At standard ambient conditions, the theoretical minimum voltage, i.e. the potential difference, required is about 1.23 volts. The minimum voltage is a thermodynamic state function dependent on a prevailing temperature and partial pressures so that an increase in the temperature will lower the voltage requirement, while a pressure increase will increase the voltage requirement. The solid lines correspond to equilibriums between different chemical species. For example, the horizontal line at −0.39 volts is the equilibrium between Ni and Ni²⁺ ions—thus only electron transfer occurs. Vertical lines indicate an acid-base reaction, i.e. a removal and an addition of a proton. The Pourbaix diagram can be divided into areas of degradation, passivation, and immunity against degradation such as corrosion. In FIG. 1, cross-hatched areas represent nickel degradation by dissolution, diagonally hatched areas represent the passivation, and horizontally hatched areas represent the immunity. Acidic conditions, i.e. pH<7, for the nickel electrodes would, over a notably wide potential range, enable the dissolution into Ni²⁺, which should be avoided. Instead, conditions which are demonstrated with two black dots in FIG. 1 mean that hydrogen gas H₂ is not generated because the cell voltage is 1.2 volts that is less than the above-mentioned 1.23 volts, and the electrodes do not degrade since the lower one of the black dots is in the immunity area whereas the upper one of the is in the passivation area. Thus, the conditions demonstrated with the two black dots in FIG. 1 are advantageous for keeping the electrochemical reactor 101 in an idle state.

In a system according to an exemplifying and non-limiting embodiment, the electrochemical reactor 101 comprises a temperature control device 107 that is configured to adjust temperature of the electrolyte and the electrodes. The controller 106 is configured to control the temperature control device 107 to change the temperature in response to a situation in which the measurement data MD indicates the formation of hydrogen gas H₂ even though the direct voltage ∪_{DC} is at most the lower limit of the safe voltage area. As mentioned above, an increase in the temperature will lower the minimum cell voltage needed for the electrolysis process. Thus, an upper limit of a voltage area where no hydrogen gas H₂ is generated can be increased by decreasing the temperature. Therefore, the temperature control can be used for finding an idle-state operating point where neither hydrogen gas H₂ generation nor electrode degradation takes place.

In a system according to an exemplifying and non-limiting embodiment, the electrochemical reactor 101 comprises a pH control device 108 configured to adjust pH of the electrolyte. The pH can be adjusted for example by adding acid or base to the electrolyte depending on whether the pH is to be increased or decreased. The controller 106 is configured to control the pH control device 108 to change the pH of the electrolyte in response to a situation in which the measurement data MD indicates the formation of the hydrogen gas H₂ even though the direct voltage ∪_{DC} is at most the lower limit of the safe voltage area. A suitable change of the pH to find an idle-state operating point, where neither hydrogen gas H₂ generation nor electrode degradation takes place, can be derived from the data describing the Pourbaix diagram.

A procedure for controlling the electrochemical reactor 101 into an idle state may comprise for example the following actions:
1) Shutting down the electrolysis process by controlling direct current of the electrochemical reactor 101 to zero.
2) Saving a value ∪_{DC1} of the direct voltage ∪_{DC} at the situation in which the direct current reaches zero.
3) Optionally, releasing the system pressure for safety purposes.
4) Optionally, purging the system with inert gas, e.g. nitrogen N₂, for safety purposes.
5) Defining a safe system pressure level based on product gas, e.g. H₂, pressure measurements.
6) Defining, according to the Pourbaix diagram, the lower limit U_{DCmin} for the safe voltage area where electrode degradation does not occur.
7) Controlling the direct voltage ∪_{DC} starting from the above-mentioned value ∪_{DC1} based on pressure measurements of the product gas, e.g. H₂, so that the direct voltage ∪_{DC} is reduced if any product gas pressure increases.
8) If any product gas pressure keeps increasing and the direct voltage ∪_{DC} is below the above-mentioned lower limit U_{DCmin}, then change the pH in the electrochemical reactor 101 and/or the temperature in the electrochemical reactor 101.

If the system is purged with inert gas, such as nitrogen N₂, during the shutdown process, the presence of the inert gas may compromise the pressure measurement of one or more product gases due to the change in the gas composition. In this case, the direct voltage ∪_{DC} can be controlled based on an output signal of the gas composition sensor 112 and/or an output signal of the gas mass flow sensor 111.

In the exemplifying system illustrated in FIG. 1, the direct voltage ∪_{DC} during the idle state, i.e. protective voltage, can be maintained and controlled with the aid of the charging converter 117. The supply of the protective voltage requires only a little electrical energy as its main purpose is to provide polarization and sufficient, controllable potential over the electrochemical cells, and therefore, the power rating of the charging converter 117 can remain low. When the charging converter 117 is used to pre-charge the direct voltage capacitor 125 during a start-up phase, the charging resistors 118 are advantageously used to limit current. In the idle state, the charging resistors 118 are advantageously bypassed to minimize losses in the protective voltage supply operation. The electrodes of the electrochemical reactor 101 can be momentarily in a corrosive region, in terms of potential of the electrodes, when switching from production use of the electrochemical reactor 101 to the idle state in which the charging converter 117 is utilized to supply the protective voltage. However, possible time spent in the corrosive region is negligible in comparison to a case where no protective voltage is ever used in the idle state. Furthermore, if release of system pressure and/or inert gas purging is required upon system shutdown for safety purposes, then such safety procedures may lead to a situation in which the electrodes of the electrochemical reactor 101 are momentarily in a corrosive region. Also in these cases, time spent in the corrosive region is negligible in comparison to a case where no protective voltage supply is ever applied in the idle state.

The controller 106 shown in FIG. 1 may comprise one or more analogue circuits, one or more digital processing circuits, or a combination thereof. Each digital processing circuit can be a programmable processor circuit provided with appropriate software, a dedicated hardware processor such as for example an application specific integrated circuit “ASIC”, or a configurable hardware processor such as for example a field programmable gate array “FPGA”. Furthermore, the controller 106 may comprise one or more memory circuits each of which can be for example a Random-Access Memory “RAM” circuit.

It is to be noted that the invention is not limited to any specific electrolysis processes. For example, a system according to an exemplifying and non-limiting embodiment may comprise an electrochemical reactor for proton exchange membrane “PEM” water electrolysis, an electrochemical reactor for a solid oxide electrolyte cell “SOEC” process, an electrochemical reactor for electrolysis of brine such as a chlor-alkali electrolysis process, or an electrochemical reactor for some other electrolysis process.

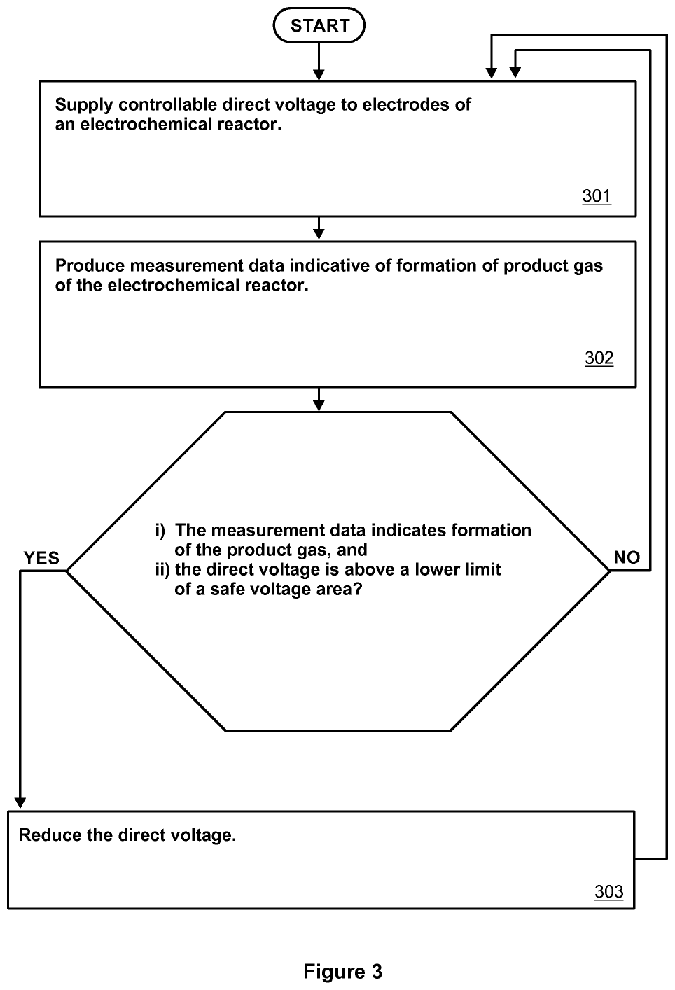

FIG. 3 shows a flowchart of a method according to an exemplifying and non-limiting embodiment for preventing degradation, such as corrosion, of electrodes of an electrochemical reactor during an idle state of the electrochemical reactor. The method comprises the following actions:
action 301: supplying controllable direct voltage to the electrodes of the electrochemical reactor,
action 302: producing measurement data indicative of formation of at least one product gas, e.g. H₂, of the electrochemical reactor, and
action 303: reducing the direct voltage in response to a situation in which i) the measurement data indicates formation of the product gas, and ii) the direct voltage is above a lower limit of a safe voltage area free from degradation of the electrodes.

In a method according to an exemplifying and non-limiting embodiment, the electrochemical reactor is one of the following: a reactor for alkaline water electrolysis, a reactor for proton exchange membrane “PEM” water electrolysis, and a reactor for electrolysis of brine.

A method according to an exemplifying and non-limiting embodiment comprises storing data descriptive of a Pourbaix diagram of materials of the electrodes and reading the lower limit of the safe voltage area from the data descriptive of the Pourbaix diagram.

A method according to an exemplifying and non-limiting embodiment comprises changing temperature of the electrodes and the electrolyte of the electrochemical reactor in response to a situation in which the measurement signal indicates the formation of the product gas even though the direct voltage is at most the lower limit of the safe voltage area.

A method according to an exemplifying and non-limiting embodiment comprises changing the pH of the electrolyte of the electrochemical reactor in response to a situation in which the measurement signal indicates the formation of the product gas even though the direct voltage is at most the lower limit of the safe voltage area.

In a method according to an exemplifying and non-limiting embodiment, the producing the measurement data comprises detecting gas pressure prevailing in a gas-space of the electrochemical reactor. In this exemplifying embodiment, an output signal of the pressure sensor represents at least a part of the measurement data indicative of the product gas formation.

In a method according to an exemplifying and non-limiting embodiment, the producing the measurement data comprises detecting gas mass flow from one or more electrolysis cells of the electrochemical reactor. In this exemplifying embodiment, an output signal of the mass flow sensor represents at least a part of the measurement data indicative of the product gas formation. The gas mass flow can be detected for example with a differential pressure flow meter and/or a thermal mass flow meter.

In a method according to an exemplifying and non-limiting embodiment, the producing the measurement data comprises detecting a relative content of the product gas within a sample of gas taken from the gas-space of the electrochemical reactor. In this exemplifying embodiment, an output signal of the gas composition sensor represents at least a part of the measurement data indicative of the product gas formation. The relative content of the product gas can be detected for example with a gas chromatographer and/or a mass spectrometer.

A computer program according to an exemplifying and non-limiting embodiment comprises computer executable instructions for controlling a programmable processor to carry out actions related to a method according to any of the above-described exemplifying and non-limiting embodiments.

A computer program according to an exemplifying and non-limiting embodiment comprises software modules for preventing degradation of electrodes of an electrochemical reactor during an idle state of the electrochemical reactor. The software modules comprise computer executable instructions for controlling a programmable processor to:
control an electric power source to supply controllable direct voltage to the electrodes of the electrochemical reactor,
receive measurement data indicative of formation of at least one product gas of the electrochemical reactor, and
control the electric power source to reduce the direct voltage in response to a situation in which i) the measurement data indicates formation of the product gas, and ii) the direct voltage is above a lower limit of a safe voltage area free from degradation of the electrodes.

The above-mentioned software modules can be e.g. subroutines or functions implemented with a suitable programming language.

A computer program product according to an exemplifying and non-limiting embodiment comprises a computer readable medium, e.g. a compact disc “CD”, encoded with a computer program according to an embodiment of invention.

A signal according to an exemplifying and non-limiting embodiment is encoded to carry information defining a computer program according to an embodiment of invention. In this exemplifying case, the computer program can be downloadable from a server that may constitute e.g. a part of a cloud service.

The specific examples provided in the description given above should not be construed as limiting the applicability and/or the interpretation of the appended claims. Lists and groups of examples provided in the description given above are not exhaustive unless otherwise explicitly stated.

1. A system for an electrochemical process, the system comprising:
an electrochemical reactor for containing electrolyte and comprising electrodes for directing electric current to the electrolyte,
an electric power source configured to supply controllable direct voltage to the electrodes of the electrochemical reactor,
a measurement apparatus configured to produce measurement data indicative of formation of at least one product gas of the system, and
a controller communicatively connected to the electric power source and to the measurement apparatus and configured to reduce the direct voltage in response to a situation in which i) the controller has received an idle command to set the system into an idle state, ii) the measurement data indicates formation of the product gas, and iii) the direct voltage is above a lower limit of a safe voltage area free from degradation of the electrodes.

2. A system according to claim 1, wherein the controller comprises a memory configured to store data descriptive of a Pourbaix diagram of materials of the electrodes, and the controller is configured to read the lower limit of the safe voltage area from the data descriptive of the Pourbaix diagram.

3. A system according to claim 1, wherein the electrochemical reactor comprises a temperature control device configured to adjust temperature of the electrolyte and the electrodes, and the controller is configured to control the temperature control device to change the temperature in response to a situation in which the measurement data indicates the formation of the product gas even though the direct voltage is at most the lower limit of the safe voltage area.

4. A system according to claim 1, wherein the electrochemical reactor comprises a pH control device configured to adjust pH of the electrolyte, and the controller is configured to control the pH control device to change the pH of the electrolyte in response to a situation in which the measurement data indicates the formation of the product gas even though the direct voltage is at most the lower limit of the safe voltage area.

5. A system according to claim 1, wherein the measurement apparatus comprises at least one pressure sensor configured to detect gas pressure prevailing in a gas-space of the electrochemical reactor, an output signal of the pressure sensor representing at least a part of the measurement data indicative of the product gas formation.

6. A system according to claim 1, wherein the measurement apparatus comprises at least one gas mass flow sensor configured to detect gas mass flow from one or more electrolysis cells of the electrochemical reactor, an output signal of the mass flow sensor representing at least a part of the measurement data indicative of the product gas formation.

7. A system according to claim 6, wherein the gas mass flow sensor comprises at least one of the following: a differential pressure flow meter, a thermal mass flow meter.

8. A system according to claim 1, wherein the measurement apparatus comprises a gas composition sensor configured to detect a relative content of the product gas within a sample of gas taken from a gas-space of the electrochemical reactor, an output signal of the gas composition sensor representing at least a part of the measurement data indicative of the product gas formation.

9. A system according to claim 8, wherein the gas composition sensor comprises the least one of the following: a gas chromatographer, a mass spectrometer.

10. A method for preventing degradation of electrodes of an electrochemical reactor during an idle state of the electrochemical reactor, the method comprising:
supplying controllable direct voltage to the electrodes of the electrochemical reactor,
producing measurement data indicative of formation of at least one product gas of the electrochemical reactor, and
reducing the direct voltage in response to a situation in which i) the measurement data indicates formation of the product gas, and ii) the direct voltage is above a lower limit of a safe voltage area free from degradation of the electrodes.

11. A method according to claim 10, wherein the electrochemical reactor is one of the following: a reactor for alkaline water electrolysis, a reactor for proton exchange membrane water electrolysis, a reactor for electrolysis of brine.

12. A method according to claim 10, wherein the method comprises storing data descriptive of a Pourbaix diagram of materials of the electrodes, and reading the lower limit of the safe voltage area from the data descriptive of the Pourbaix diagram.

13. A method according to claim 10, wherein the method comprises changing temperature of the electrodes and electrolyte of the electrochemical reactor in response to a situation in which the measurement signal indicates the formation of the product gas even though the direct voltage is at most the lower limit of the safe voltage area.

14. A method according to claim 10, wherein the method comprises changing the pH of electrolyte of the electrochemical reactor in response to a situation in which the measurement signal indicates the formation of the product gas even though the direct voltage is at most the lower limit of the safe voltage area.

15. A non-transitory computer readable medium encoded with a computer program for preventing degradation of electrodes of an electrochemical reactor during an idle state of the electrochemical reactor, the computer program comprising computer executable instructions for controlling a programmable processor to:
control an electric power source to supply controllable direct voltage to the electrodes of the electrochemical reactor,
receive measurement data indicative of formation of at least one product gas of the electrochemical reactor, and
control the electric power source to reduce the direct voltage in response to a situation in which i) the measurement data indicates formation of the product gas, and ii) the direct voltage is above a lower limit of a safe voltage area free from degradation of the electrodes.

16. (canceled)

17. A system according to claim 2, wherein the electrochemical reactor comprises a temperature control device configured to adjust temperature of the electrolyte and the electrodes, and the controller is configured to control the temperature control device to change the temperature in response to a situation in which the measurement data indicates the formation of the product gas even though the direct voltage is at most the lower limit of the safe voltage area.

18. A system according to claim 2, wherein the electrochemical reactor comprises a pH control device configured to adjust pH of the electrolyte, and the controller is configured to control the pH control device to change the pH of the electrolyte in response to a situation in which the measurement data indicates the formation of the product gas even though the direct voltage is at most the lower limit of the safe voltage area.

19. A system according to claim 3, wherein the electrochemical reactor comprises a pH control device configured to adjust pH of the electrolyte, and the controller is configured to control the pH control device to change the pH of the electrolyte in response to a situation in which the measurement data indicates the formation of the product gas even though the direct voltage is at most the lower limit of the safe voltage area.

20. A system according to claim 2, wherein the measurement apparatus comprises at least one pressure sensor configured to detect gas pressure prevailing in a gas-space of the electrochemical reactor, an output signal of the pressure sensor representing at least a part of the measurement data indicative of the product gas formation.
